(19) United States
(12) Patent Application Publication
(10) Pub. No.: US 2019/0005905 A1
(43) Pub. Date: Jan. 3, 2019

(54) DRIVING CIRCUIT OF DISPLAY APPARATUS AND DISPLAY APPARATUS

(71) Applicants: HKC CORPORATION LIMITED, Shenzhen, Guangdong (CN); CHONGQING HKC OPTOELECTRONICS TECHNOLOGY CO., LTD., Jieshi, Chongqing (CN)

(72) Inventor: Yu-jen CHEN, Jieshi (CN)

(73) Assignees: HKC Corporation Limited, Shenzhen, Guangdong (CN); Chongqing HKC Optoelectronics Technology Co., Ltd., Jeshi, Chongqing (CN)

(21) Appl. No.: 15/744,250

(22) PCT Filed: Jul. 26, 2017
(86) PCT No.: PCT/CN2017/094546

§ 371 Date: Jan. 12, 2018

(30) Foreign Application Priority Data
May 22, 2017 (CN) 201710361948.3

(51) Int. Cl. G09G 3/36

(52) U.S. Cl. CPC G09G 3/3618; G09G 3/3677; G09G 3/3225; G09G 2310/0243; G09G 2320/0252

(57) ABSTRACT

A driving circuit of a display apparatus and a display apparatus are provided. A first gate signal output module of the driving circuit is electrically connected to a first pixel unit group through first gate lines. A second gate signal output module is electrically connected to a second pixel unit group through second gate lines. A data signal output module is electrically connected to the first pixel unit group through first data lines. A second data signal output module is electrically connected to the second pixel unit groups through second data lines. When displaying an image frame, gate driving signals and data signals are outputted to the first pixel unit group and the second pixel unit group simultaneously.

### TECHNICAL FIELD

The present disclosure relates to a driving circuit of a display apparatus and a display apparatus.

### BACKGROUND

A display apparatus can visually display texts, numerals, symbols, images and the like, and thus is widely used and studied. A Thin Film Transistor Liquid Crystal Display (TFT-LCD), as one of main kinds of current panel display, has become an important display platform in modern IT and video products.

The TFT-LCD is driven mainly by connecting a color filter compression signal, a control signal and a power with a connector on a control board through wires by virtue of a system main board, and connecting data with a display region through a Timing Controller (TCON) on the control board, a flexible circuit board, a Source-Chip on Film (S-COF) and a Gate-Chip on Film (G-COF), so that the LCD acquires required gate driving signals and data signals. In a relevant technology, S-COF and G-COF are used for controlling to turn on the TFT in each row/column of pixel units successively, thereby presenting a picture.

However, with the development of display technology, a requirement for a resolution of a display picture is increasingly high, and the above driving mode cannot meet the requirement for the quality of the display picture. Meanwhile, a refresh rate of the display apparatus cannot be further improved due to a temperature problem of the COF and other problems.

### SUMMARY

The present disclosure provides a driving circuit of a display apparatus, a driving method and a display apparatus, to solve a low picture refresh rate problem of a display panel, so as to improve display quality.

The driving circuit of the display apparatus provided by the present disclosure includes: a first gate signal output module electrically connected to a first pixel unit group through a first group of gate lines;

a second gate signal output module electrically connected to a second pixel unit group through a second group of gate lines;

a first data signal output module electrically connected to the first pixel unit group through a first group of data lines, and configured to output data signals to data lines in the first group of data lines; and

a second data signal output module electrically connected to the second pixel unit group through a second group of data lines, and configured to output data signals to data lines in the second group of data lines.

When displaying an image frame, the first gate signal output module is configured to output a gate driving signal to gate lines in the first group of gate lines successively; and the second gate signal output module is configured to: output the gate driving signal to gate lines in the second group of gate lines successively while the first gate signal output module is outputting the gate driving signal to the gate lines in the first group of gate lines successively.

A display apparatus provided by the present disclosure includes a display panel and the above driving circuit of the display apparatus.

The display apparatus is a liquid crystal display apparatus or an organic light emitting diode display apparatus.

The present disclosure further provides another display apparatus, including a display panel and a driving circuit.

The display panel includes: m gate lines including i first gate lines and j second gate lines; 2n data lines including n first data lines and n second data lines and a pixel unit array including pixel units arranged in m rows and n columns.

The driving circuit includes: a first gate signal output module electrically connected to the i first gate lines; a second gate signal output module electrically connected to the j first gate lines; a first data signal output module electrically connected to the n first data lines; and a second data signal output module electrically connected to the n second data lines.

The pixel units of the pixel unit array includes i first pixel unit groups and j second pixel unit groups. Each first pixel unit group is electrically connected to a respective one of the i first gate lines, and electrically connected to the n first data lines. Each second pixel unit group is electrically connected to a respective one of the j second gate lines, and electrically connected to the n second data lines, where i, j, m and n are positive integers greater than 1, and i+j=m.

### BRIEF DESCRIPTION OF DRAWINGS

FIG. 1 is a block diagram illustrating a basic structure of a driving circuit of a display apparatus provided by embodiments of the present disclosure;

FIG. 2A is a flow chart illustrating a driving method of a driving circuit of a display apparatus provided by embodiments of the present disclosure;

FIG. 2B is a diagram illustrating a charging timing of a driving method of a display panel provided by embodiments of the present disclosure;

FIG. 3 is a structural schematic diagram of a display region in a display apparatus provided by embodiments of the present disclosure;

FIG. 4 is a structural schematic diagram of pixel unit group of a display region divided in rows in a display apparatus provided by embodiments of the present disclosure;

FIG. 5 is a structural schematic diagram of pixel unit group of a display region divided in columns in a display apparatus provided by embodiments of the present disclosure;

FIG. 6 is a structural schematic diagram of a display apparatus and a driving circuit thereof provided by embodiments of the present disclosure;

FIG. 7 is a driving structural diagram of a thin film transistor liquid crystal display provided by embodiments of the present disclosure;

FIG. 8 is a structural schematic diagram of a display apparatus provided by embodiments of the present disclosure;

FIG. 9 is a structural schematic diagram of another display apparatus provided by embodiments of the present disclosure;

FIG. 10 is a structural schematic diagram of another display apparatus provided by embodiments of the present disclosure; and

FIG. 11 is a driving sequence diagram of the display apparatus in FIG. 10.

### DETAILED DESCRIPTION

The present disclosure is further described in detail below with reference to drawings and embodiments. It can be understood that specific embodiments described herein are only for explaining the present disclosure, rather than limiting the present disclosure. In addition, it should also be noted that, the accompanying drawings just illustrate part of structures related to the present disclosure, rather than all structures, so as to facilitate the description.

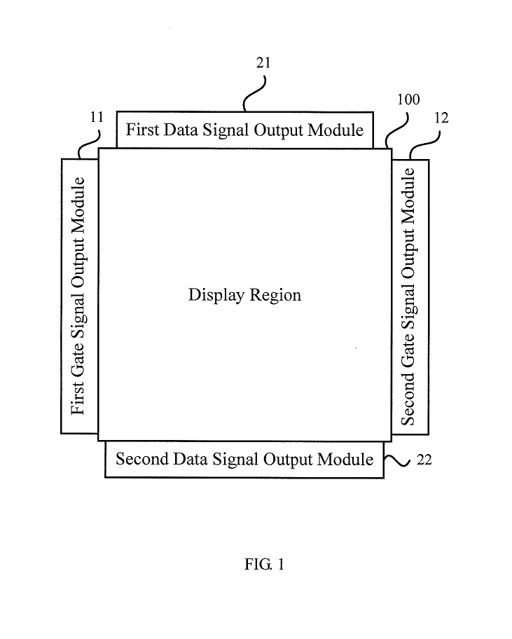

The present disclosure provides a driving circuit of a display apparatus. FIG. 1 is a structural block diagram of the driving circuit of the display apparatus provided by embodiments of the present disclosure. As shown in FIG. 1, the driving circuit includes: a first gate signal output module 11, a second gate signal output module 12, a first data signal output module 21 and a second data signal output module 22.

Exemplarily, a display panel of a Thin Film Transistor Liquid Crystal Display (TFT-LCD) includes a display region and a non-display region. Generally, wires, detection points, a driving circuit and the like may be arranged in the non-display region. A plurality of gate lines and a plurality of data lines crosswise arranged, as well as a plurality of pixel units arranged in rows and columns are provided in the display region. Gate electrodes are located in the pixel units, and a Thin Film Transistor (TFT) is used as a pixel switch. A gate driving circuit outputs the gate driving signal to the gate electrodes of the plurality of gate lines successively, and each of the gate lines transmits the gate driving signals to the gate electrode of the TFT of a corresponding row of pixel units, so that the TFT is turned on. At this time, a storage capacitor of the pixel unit is charged through the data line via the turned-on TFT, to written in a grayscale voltage. After the TFT is turned off, the storage capacitor continues to maintain the grayscale voltage, and the grayscale voltage is updated until the TFT of the pixel unit is turned on again, thereby updating a display picture.

Thus, the driving circuit of the display apparatus of embodiments of the present disclosure is configured to drive a display region 100 for image display. A plurality of data lines and a plurality of scanning lines in the display region are electrically connected to the plurality of pixel units. The first gate signal output module 11 in the driving circuit is electrically connected to a first pixel unit group through a first group of gate lines, and configured to output the gate driving signal to the first group of gate lines successively. The second gate signal output module 12 is electrically connected to a second pixel unit group through a second group of gate lines, and configured to output the gate driving signal to the second group of gate lines successively. The first data signal output module 21 is electrically connected to the first pixel unit group through a first group of data lines, and configured to output data signals to the first group of data lines successively. The second data signal output module 22 is electrically connected to the second pixel unit group through second data lines, and configured to output data signals to the second data lines successively.

In display images of each frame, the first gate signal output module 11 and the second gate signal output module 12 output the gate driving signals simultaneously, and the first data signal output module 21 and the second data signal output module 22 output the data signals simultaneously.

In the driving circuit of the display apparatus provided by embodiments of the present disclosure, the first gate signal output module is electrically connected to the first pixel unit group through first gate lines, the second gate signal output module is electrically connected to the second pixel unit group through second gate lines, the data signal output module is electrically connected to the first pixel unit group through first data lines, the second data signal output module is electrically connected to the second pixel unit group through second data lines, and when displaying each frame of an image, the gate driving signals and the data signals are outputted to the first pixel unit group and the second pixel unit group simultaneously, thereby reducing a scanning time of the display images of each frame, improving the refresh rate of the display apparatus, and further improving the display quality of the display picture.

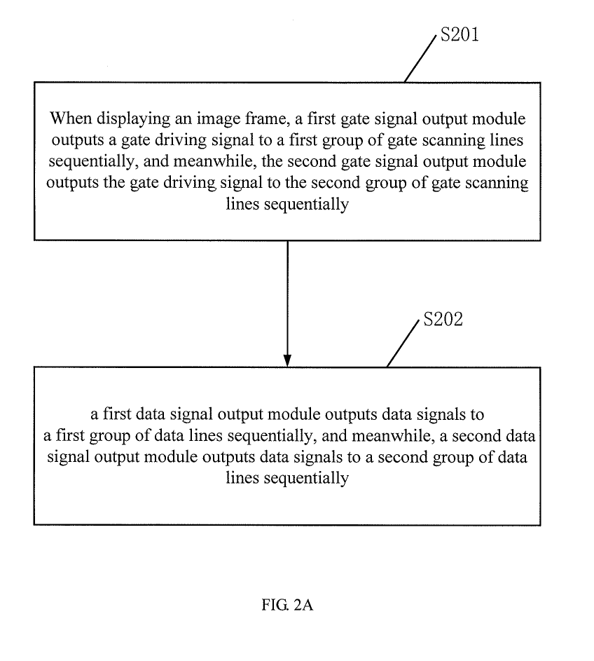

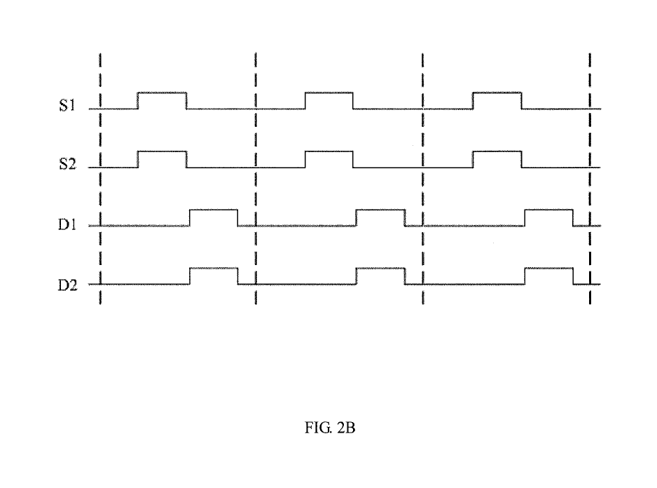

The driving circuit of display apparatus updates the display picture by turning on the TFT in each pixel unit in the display region 100, and the driving method of the driving circuit is shown in FIG. 2A. FIG. 2A is a flow chart illustrating a driving method of a driving circuit of a display apparatus provided by embodiments of the present disclosure. The driving method includes:

At S201, when displaying each frame of an image, the first gate signal output module outputs the gate driving signal to the first group of gate lines successively, and meanwhile, the second gate signal output module outputs the gate driving signal to the second group of gate lines successively.

At S202, the first data signal output module outputs the data signals to the first group of data lines successively, and meanwhile, the second data signal output module outputs the data signals to the second group of data lines.

Exemplarily, FIG. 2B is a charging timing diagram of the driving method of the display panel provided by embodiments of the present disclosure. As shown in FIG. 2B, when displaying each frame of an image, the first gate signal output module 11 and the second gate signal output module 12 output the gate driving signals S1 and S2 simultaneously, so that the first gate signal output module 11 outputs the gate driving signal to the first group of gate lines successively, and the second gate signal output module 12 outputs the gate driving signal to the second group of gate lines successively. At this moment, TFTs in the first pixel unit group electrically connected to the first group of gate lines are are turned on successively, and TFTs in the second pixel unit group electrically connected to the second group of gate lines are also turned on successively. The first data signal output module 21 and the second data signal output module 22 output the data signals D1 and D2 simultaneously, so that the first data signal output module 21 outputs data signals to the first group of data signal lines, and the second data signal output module 22 outputs data signals to the second group of data signal lines. At this moment, pixel grayscale voltages are written into the TFTs in the first pixel unit group electrically connected to the first group of data signal lines successively, meanwhile, the pixel grayscale voltages are written into the TFTs in the second pixel unit group electrically connected to the second group of data signal lines successively. In this way, the TFTs of two rows or two columns of pixel units are turned on simultaneously, and the pixel grayscale voltage are simultaneously written in, thereby improving the refresh rate of the display picture.

The driving circuit of the display apparatus provided by embodiments of the present disclosure is electrically connected to the pixel units of the display apparatus through the gate lines and the data lines. By referring to FIG. 1, the first gate signal output module 11 of the driving circuit is electrically connected to the first pixel unit group through the first gate lines, the second gate signal output module 12 is electrically connected to the second pixel unit group through the second gate lines, the first data signal output module 21 is electrically connected to the first pixel unit group through the first group of data lines, and the second data signal output module 22 is electrically connected to the second pixel unit group through the second group of data lines. The first pixel unit group may be odd-numbered rows of pixel units, and the second pixel unit group may be even-numbered rows of pixel units.

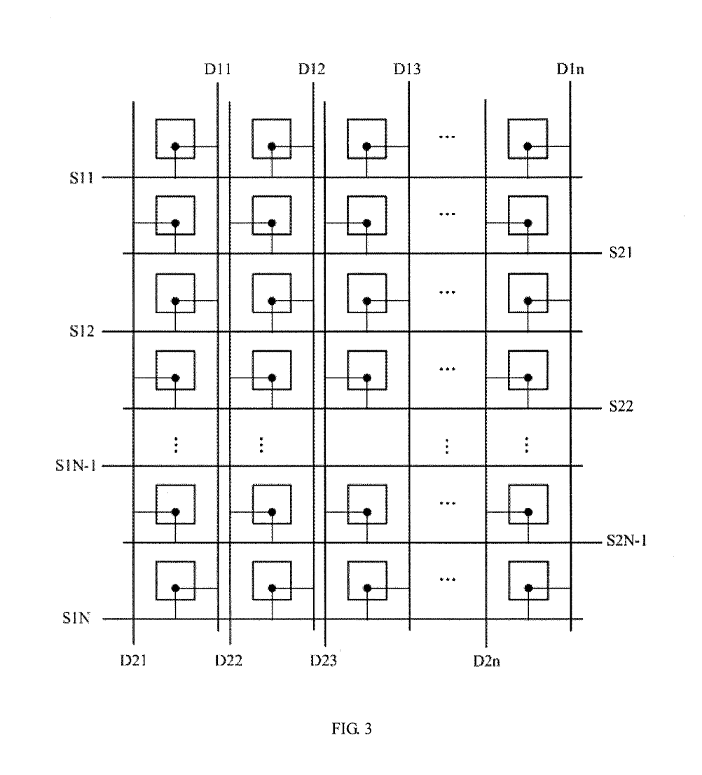

FIG. 3 is a structural schematic diagram of a display region in a display apparatus provided by embodiments of the present disclosure. M rows and n columns of pixel units are provided in the display region of the display apparatus. When M is an odd number, as shown in FIG. 3, the first group of gate lines S11, S12, . . . , S1N−1 and S1N are electrically connected to the odd-numbered rows of pixel units respectively, the first group of data lines D11, D12, D13, . . . , D1n are electrically connected to pixel units in odd-numbered rows among pixel units of each column respectively, and the odd-numbered rows of pixel units herein are the first pixel unit group. The second group of gate lines S21, S22, . . . , S2N−1 are electrically connected to the even-numbered rows of pixel units respectively, the second group of data lines D21, D22, D23, . . . , D2n are electrically connected to pixel units in even-numbered rows among pixel units of each column respectively, and the even-numbered rows of pixel units herein are the second pixel unit group. N is (M+1)/2. At this moment, the first gate signal output module is electrically connected to the odd-numbered rows of pixel units through the first group of gate lines S11, S12, . . . , S1N−1 and S1N respectively, and the first data signal output module is electrically connected to pixel units in odd-numbered rows among pixel units of each column through the first group of data lines D11, D12, D13, . . . , D1n respectively; the second gate signal output module is electrically connected to the even-numbered rows of pixel units through the second group of gate lines S21, S22, . . . , S2N−1 respectively, and the second data signal output module is electrically connected to pixel units in even-numbered rows among pixel units of each column through the second group of data lines D21, D22, D23, . . . , D2n respectively. In addition, number of rows M of the pixel units may also be an even number, and a connection manner and a drive principle thereof are similar to those when M is an odd number, so details are not repeated herein.

At this moment, when displaying each frame of an image, TFTs in each odd-numbered row of pixel units and the TFTs of the adjacent even-numbered row of pixel units below the same are turned on and written in the data signal simultaneously. For example, TFTs in the first row of pixel units electrically connected to the gate line S11 and the TFTs in the second row of pixel units electrically connected to the gate line S21 are turned on simultaneously, and data signals are written into the odd-numbered rows and even-numbered rows of pixel units through the data lines successively, so that the first row of pixel units and the second row of pixel units display the pixel grayscale simultaneously.

Optionally, the first pixel unit group and the second pixel unit group in the display region of the display apparatus may also be divided into two regions according to the rows or the columns of the pixel units, namely, the first pixel unit group may be the first N rows of pixel units or the first N columns of pixel units, and the second pixel unit group can be the last M rows of pixel units or the last M columns of pixel units.

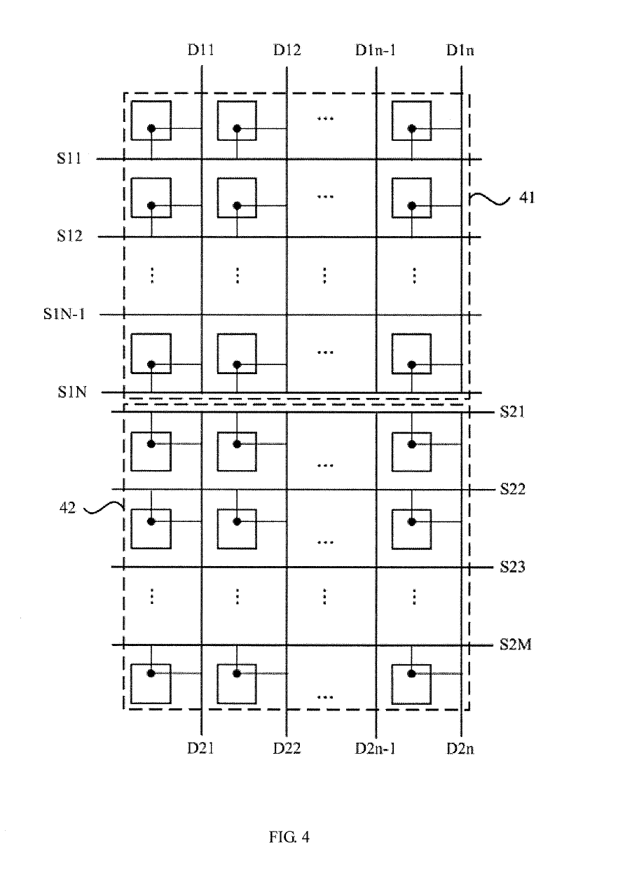

By referring to FIG. 4, FIG. 4 is a structural schematic diagram illustrating the pixel unit groups of the display region divided in rows in the display apparatus provided by embodiments of the present disclosure. N+M rows and n columns of pixel units are provided in the display region of the display apparatus. The first group of gate lines S11, S12, . . . , S1N−1 and S1N are electrically connected to the first N rows of pixel units respectively, and the first group of data lines D11, D12, . . . , D1n−1 and D1n are electrically connected to the first N rows of pixel units among pixel units in each column respectively; and the second group of gate lines S21, S22, S23, . . . , S2M are electrically connected to the last M rows of pixel units respectively, and the second group of data lines D21, D22, D23, . . . , D2n are electrically connected to the last M rows of pixel units among pixel units in each column respectively. Herein, the first N rows of pixel units are first pixel units 41, and the last M rows of pixel units are the second pixel unit group 42. At this moment, the first gate signal output module is electrically connected to the first N rows of pixel units through the first group of gate lines S11, S12, . . . , S1N−1 and S1N respectively, and the first data signal output module is electrically connected to the first N rows of pixel units among pixel units in each column through the first group of data lines D11, D12, . . . , D1n−1 and D1n respectively; and the second gate signal output module is electrically connected to the last M rows of pixel units through the second group of gate lines S21, S22, S23, . . . , S2M respectively, and the second data signal output module is electrically connected to the last M rows of pixel units among pixel units in each column through the second group of data lines D21, D22, . . . , D2n−1 and D2n respectively.

Exemplarily, when displaying each frame of an image, the first gate signal output module turns on the TFTs of the first row of pixel units through the gate line S11, and meanwhile, the second gate signal output module turns on the TFTs of the N+1 row of pixel units through the gate line S21; and the first data signal output module writes in the corresponding grayscale voltages to the first row of pixel units through the first group of data lines, and meanwhile, the second data signal output module writes in the corresponding grayscale voltages to the N+1 row of pixel units through the second group of data lines, so that the first row of pixel units and the N+1 row of pixel units display the pixel grayscales simultaneously. The display principle of the pixel grayscales of other rows of pixel units is similar to this, and is not repeated herein.

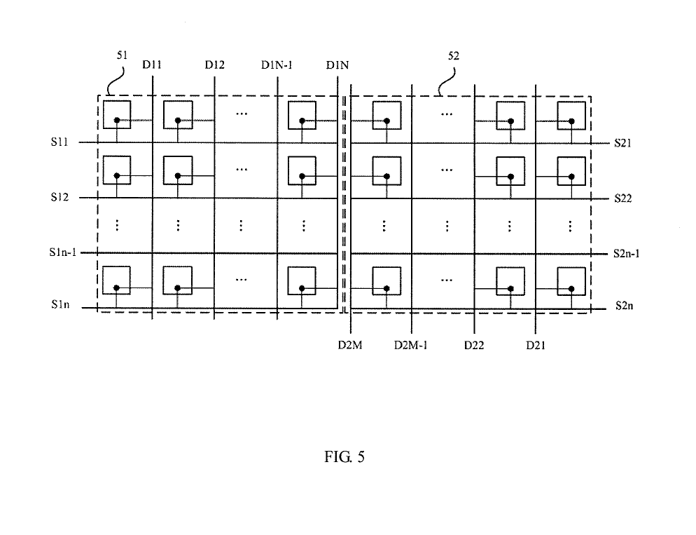

By referring to FIG. 5, FIG. 5 is a structural schematic diagram illustrating pixel unit groups of a display region divided in columns in a display apparatus provided by embodiments of the present disclosure. n rows and N+M columns of pixel units are provided in the display region of the display apparatus. The first group of gate lines S11, S12, . . . , S1N−1 and S1N are electrically connected to the first N columns of pixel units among pixel units in each row respectively, and the first group of data lines D11, D12, . . . , D1n−1 and D1n are electrically connected to the first N columns of pixel units respectively; and the second group of gate lines S21, S2d2, . . . , S2n−1 and S2n are electrically connected to the last M columns of pixel units among pixel units in each row respectively, and the second group of data lines D21, D22, . . . , D2M−1 and D2M is electrically connected to the last M columns of pixel units respectively. Herein, the first N columns of pixel units are first pixel units 51, and the last M columns of pixel units are the second pixel unit group 52. At this moment, the first gate signal output module is electrically connected to the first N columns of pixel units among pixel units in each row through the first group of gate lines S11, S12, . . . , S1N−1 and S1N respectively, and the first data signal output module is electrically connected to the first N columns of pixel units through the first group of data lines D11, D12, . . . , D1n−1 and D1n respectively; and the second gate signal output module is electrically connected to the last M columns of pixel units among pixel units in each row through the second group of gate lines S21, S22, . . . , S2n−1 and S2n respectively, and the second data signal output module is electrically connected to the last M columns of pixel units through the second group of data lines D21, D22, . . . , D2M−1 and D2M respectively. The driving principle thereof is similar to that when dividing in rows, and is not repeated herein.

Optionally, the gate lines extend in a first direction and are arranged in a second direction, and the data lines extend in the second direction and are arranged in the first direction. The first direction herein may be a direction the same as the rows of the pixel units, and the second direction may be a direction the same as the columns of the pixel units.

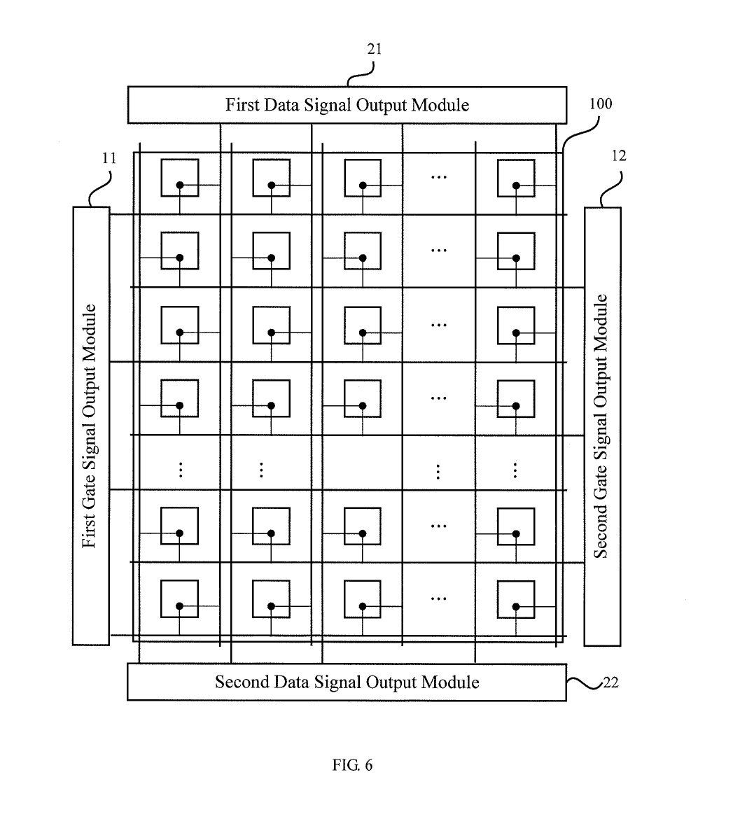

FIG. 6 is a structural schematic diagram of a display apparatus and a driving circuit thereof provided by embodiments of the present disclosure. By referring to FIG. 6, the first gate signal output module 11 and the second gate signal output module 12 are respectively arranged at two sides of the display apparatus in the first direction. When the first direction in FIG. 6 is a direction of the rows of the pixel units, the first gate signal output module 11 is arranged on the left side of the display region 100 and the second gate signal output module 12 is arranged on the right side of the display region 100. The first data signal output module 21 and the second data signal output module 22 are respectively arranged at two sides of the display apparatus in the second direction. When the second direction in FIG. 6 is a direction of the columns of the pixel units, the first data signal output module 21 is arranged on the top side of the display region 100, and the second data signal output module 22 is arranged on the bottom side the display region 100.

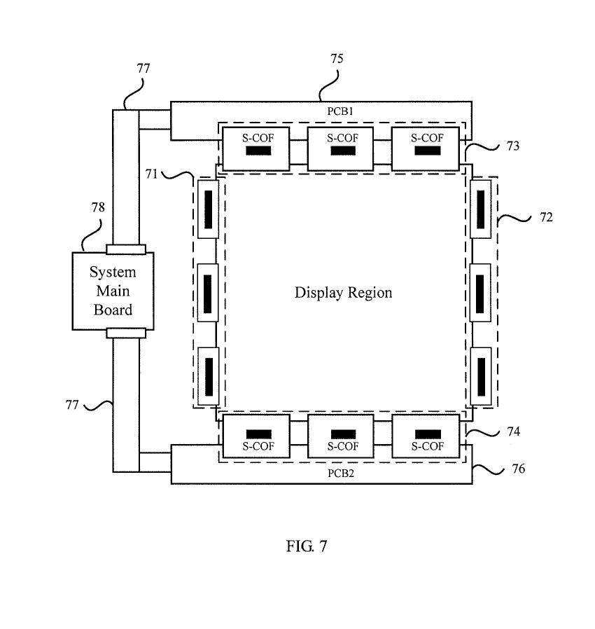

Optionally, FIG. 7 is a driving structural diagram of a thin film transistor liquid crystal display provided by embodiments of the present disclosure. As shown in FIG. 7, the first gate signal output module 11 is arranged in a first gate Chip On Film (COF) region 71, and the second gate signal output module 12 is arranged in a second gate Chip On Film (COF) region 72; and the first data signal output module 21 is arranged in a first source Chip On Film (COF) region 73, and the second gate signal output module 22 is arranged in a second source Chip On Film (COF) region 74. A signal output module is arranged in the COF area, to realize arrangement of a narrow frame of the display panel.

At this moment, the first source COF region 73 can be electrically connected to a first flexible circuit board 75, and the second source COF region 74 is electrically connected to a second flexible circuit board 76. The first flexible circuit board 75 and the second flexible circuit board 76 are connected to a system main board 78 through a Flexible Flat Cable (FFC) 77, and the system main board sends a timing control signal and the like, so that a corresponding picture is displayed in the display region of the display apparatus.

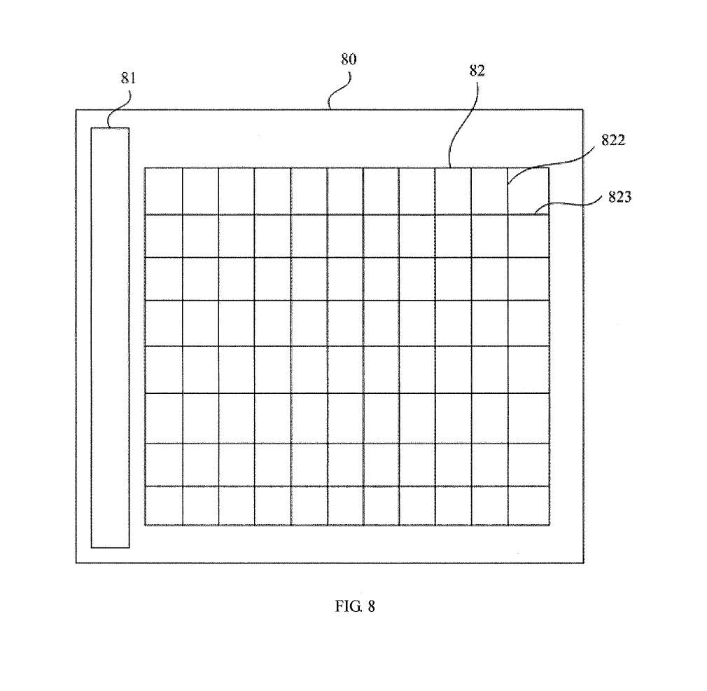

FIG. 8 is a structural schematic diagram of a display apparatus provided by embodiments of the present disclosure. The display apparatus 80 includes a display panel 82 and the driving circuit 81 of display apparatus provided by embodiments of the present disclosure. The display panel 82 includes a plurality of gate lines 823 and a plurality of data lines 822. The plurality of scanning lines 823 intersect the plurality of data lines 822 so as to form a plurality of pixel units.

In some embodiments, the display apparatus 80, for example, may be an LCD display apparatus, an OLED display apparatus, a QLED display apparatus, a curved surface display apparatus or other display apparatuses.

The present disclosure further provides another display apparatus. The display apparatus includes a display panel and a driving circuit.

The drive panel includes: m gate lines, 2n data lines and m*n pixel units. The pixel units are arranged in an array of m rows and n columns. Each pixel unit includes a thin film transistor.

The driving circuit includes a first gate signal output module, a second gate signal output module, a first data signal output module and a second data signal output module.

The m gate lines correspond to the m rows of a pixel unit array in a one-to-one correspondence. Each gate line is electrically connected to the gate electrodes of the TFTs of the n pixel units in the corresponding row.

The m gate lines include i first gate lines and j second gate lines. The i first gate lines are electrically connected to the first gate signal output module, and the j second gate lines are electrically connected to the second gate signal output module. i and j are positive integers greater than or equal to 1, and i+j=m.

The 2n data lines include n first data lines and n second data lines. The n first data lines are electrically connected to the first data signal output module. The n second data lines are electrically connected to the second data signal output module.

Each column of pixel units corresponds to a respective one of the n first data lines and a respective one of the n second data lines. In the m pixel units in each column, source electrodes of the TFTs of i pixel units are electrically connected to the corresponding first data line, and source electrodes of the TFTs of j pixel units are electrically connected to the corresponding second data line.

When displaying each frame of an image, the first gate signal output module outputs a gate driving signal to the i first gate lines successively, and the second gate signal output module outputs the gate driving signal to the j second gate lines successively while the first gate signal output module is outputting the gate driving signal to the i first gate lines successively.

Optionally, i=j, the i first pixel unit groups are odd-numbered rows of the pixel unit array, and the j second pixel unit groups are even-numbered rows of the pixel unit array.

Optionally, the i first pixel unit groups are i rows of the pixel unit array, and the j second pixel unit groups are other j rows of the pixel unit array.

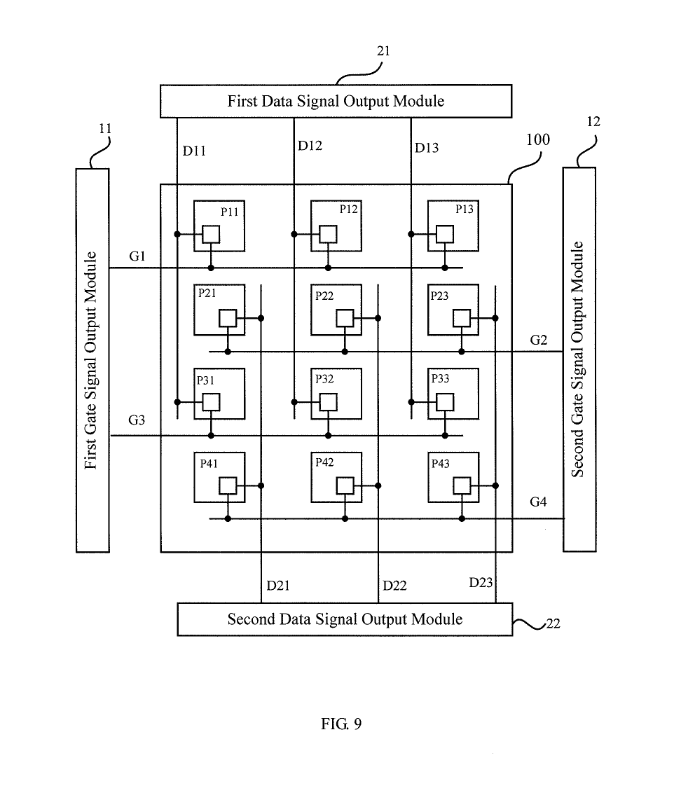

FIG. 9 shows an example of a display apparatus. As shown in FIG. 9, the display apparatus includes a display panel 100 and a driving circuit.

The driving circuit includes a first gate signal output module 11, a second gate signal output module 12, a first data signal output module 21 and a second data signal output module 22.

The display panel 100 includes 4 gate lines, 6 data lines and 12 pixel units. The 12 pixel units are arranged in an array of 4 rows and 3 columns.

The 4 gate lines include a gate line G1, a gate line G2, a gate line G3 and a gate line G4. The gate line G1 and the gate line G3 are the first gate lines, and the gate line G2 and the gate line G4 are the second gate lines.

The 6 data lines include a data line D11, a data line D12, a data line D13, a data line D21, a data line D22 and a data line D23. The data line D11, the data line D12 and the data line D13 are the first data lines, and the data line D21, the data line D22 and the data line D23 are the second data lines.

The gate line G1 and the gate line G3 are electrically connected to the first gate signal output module 11 respectively. The gate line G2 and the gate line G4 are electrically connected to the second gate signal output module 12 respectively. The data line D11, the data line D12 and the data line D13 are electrically connected to the first data signal output module 21 respectively. The data line D21, the data line D22 and the data line D23 are electrically connected to the second data signal output module 22 respectively.

Each pixel unit is provided with a TFT. The TFT is provided with a source electrode, a drain electrode and a gate electrode. The 12 pixel unites include a pixel unit P11, a pixel unit P12, a pixel unit P13, a pixel unit P21, a pixel unit P22, a pixel unit P23, a pixel unit P31, a pixel unit P32, a pixel unit P33, a pixel unit P41, a pixel unit P42 and a pixel unit P43.

The gate electrodes of the TFTs of the first row of pixel units (the pixel unit P11, the pixel unit P12 and the pixel unit P13) are electrically connected to the gate line G1; and the source electrodes of the TFTs of the first row of pixel units are electrically connected to the data line D11, the data line D12 and the data line D13 respectively.

The gate electrodes of the TFTs of the second row of pixel units (the pixel unit P21, the pixel unit P22 and the pixel unit P23) are electrically connected to the gate line G2; and the source electrodes of the TFTs of the second row of pixel units are electrically connected to the data line D21, the data line D22 and the data line D23 respectively.

The gate electrodes of the TFTs of the third row of pixel units (the pixel unit P31, the pixel unit P32 and the pixel unit P33) are electrically connected to the gate line G3; and the source electrodes of the TFTs of the third row of pixel units are electrically connected to the data line D11, the data line D12 and the data line D13 respectively.

The gate electrodes of the TFTs of the fourth row of pixel units (the pixel unit P41, the pixel unit P42 and the pixel unit P43) are electrically connected to the gate line G4; and the source electrodes of the TFTs of the fourth row of pixel units are electrically connected to the data line D21, the data line D22 and the data line D23 respectively.

At a first time period, the first gate signal output module 11 outputs the gate driving signal to the gate line G1, the second gate signal output module 12 outputs the gate driving signal to the gate line G2, the first data signal output module 21 outputs data signals to the first row of pixel units (the pixel unit P11, the pixel unit P12 and the pixel unit P13) through the data lines D11, D12 and D13 respectively; and the second data line signal output module 22 outputs data signals to the second row of pixel units (the pixel unit P21, the pixel unit P22 and the pixel unit P23) through the data lines D21, D22 and D23 respectively. In the first time period, the first row of pixel units and the second row of pixel units are driven simultaneously.

At a second time period, the first gate signal output module 11 outputs the gate driving signal to the gate line G3, the second gate signal output module 12 outputs the gate driving signal to the gate line G4, the first data signal output module 21 outputs data signals to the third row of pixel units (the pixel unit P31, the pixel unit P32 and the pixel unit P33) through the data lines D11, D12 and D13 respectively; and the second data line signal output module 22 outputs data signals to the fourth row of pixel units (the pixel unit P41, the pixel unit P42 and the pixel unit P43) through the data lines D21, D22 and D23 respectively. In the second time period, the third row of pixel units and the fourth row of pixel units are driven simultaneously.

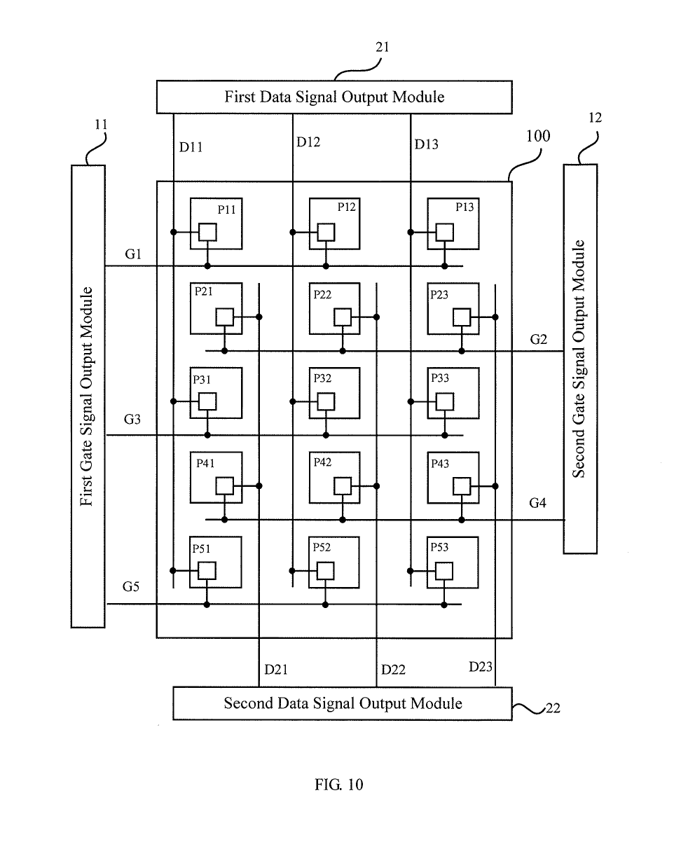

FIG. 10 shows another example of a display apparatus. As shown in FIG. 10, the display apparatus includes a display panel 100 and a driving circuit.

The driving circuit includes a first gate signal output module 11, a second gate signal output module 12, a first data signal output module 21 and a second data signal output module 22.

The display panel 100 includes 5 gate lines, 6 data lines and 15 pixel units. The 15 pixel units are arranged in an array of 5 rows and 3 columns.

The 5 gate lines include a gate line G1, a gate line G2, a gate line G3, a gate line G4 and a gate line G5. The gate line G1, the gate line G3 and the gate line G5 are the first gate lines; and the gate line G2 and the gate line G4 are the second gate lines.

The 6 data lines include a data line D11, a data line D12, a data line D13, a data line D21, a data line D22 and a data line D23. The data line D11, the data line D12 and the data line D13 are the first data lines; and the data line D21, the data line D22 and the data line D23 are the second data lines.

The first gate lines (the gate line G1, the gate line G3 and the gate line G5) are electrically connected to the first gate signal output module 11 respectively. The second gate lines (the gate line G2 and the gate line G4) are electrically connected to the second gate signal output module 12 respectively. The first data lines (the data line D11, the data line D12 and the data line D13) are electrically connected to the first data signal output module 21 respectively. The second data lines (the data line D21, the data line D22 and the data line D23) are electrically connected to the second data signal output module 22 respectively.

Each pixel unit is provided with a TFT. The TFT is provided with a source electrode, a drain electrode and a gate electrode. The 15 pixel units include a pixel unit P11, a pixel unit P12, a pixel unit P13, a pixel unit P21, a pixel unit P22, a pixel unit P23, a pixel unit P31, a pixel unit P32, a pixel unit P33, a pixel unit P41, a pixel unit P42, a pixel unit P43, a pixel unit P51, a pixel unit P52 and a pixel unit P53.

The gate electrodes of the TFTs of the first row of pixel units (the pixel unit P11, the pixel unit P12 and the pixel unit P13) are electrically connected to the gate line G1; and the source electrodes of the TFTs of the first row of pixel units are electrically connected to the data line D11, the data line D12 and the data line D13 respectively.

The gate electrodes of the TFTs of the second row of pixel units (the pixel unit P21, the pixel unit P22 and the pixel unit P23) are electrically connected to the gate line G2; and the source electrodes of the TFTs of the second row of pixel units are electrically connected to the data line D21, the data line D22 and the data line D23 respectively.

The gate electrodes of the TFTs of the third row of pixel units (the pixel unit P31, the pixel unit P32 and the pixel unit P33) are electrically connected to the gate line G3; and the source electrodes of the TFTs of the third row of pixel units are electrically connected to the data line D11, the data line D12 and the data line D13 respectively.

The gate electrodes of the TFTs of the fourth row of pixel units (the pixel unit P41, the pixel unit P42 and the pixel unit P43) are electrically connected to the gate line G4; and the source electrodes of the TFTs of the fourth row of pixel units are electrically connected to the data line D21, the data line D22 and the data line D23 respectively.

The gate electrodes of the TFTs of the fifth row of pixel units (the pixel unit P51, the pixel unit P52 and the pixel unit P53) are electrically connected to the gate line G5; and the source electrodes of the TFTs of the fifth row of pixel units are electrically connected to the data line D11, the data line D12 and the data line D13 respectively.

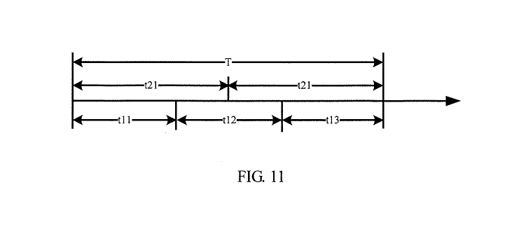

FIG. 11 shows a timing diagram for displaying an image frame by the display apparatus. To display an image frame, the display apparatus needs a time T. The time T can be divided into three time periods: t11, t12 and t13. The time T can also be divided into two time periods: t21 and t22.

At the time period t11, the first gate signal output module 11 outputs the gate driving signal to the gate line G1, and the first data signal output module 21 outputs the data signals to the first row of pixel units (the pixel unit P11, the pixel unit P12 and the pixel unit P13) through the data lines D11, D12 and D13 respectively.

At the time period t12, the first gate signal output module 11 outputs the gate driving signal to the gate line G3, and the first data signal output module 21 outputs the data signals to the third row of pixel units (the pixel unit P31, the pixel unit P22 and the pixel unit P33) through the data lines D11, D12 and D13 respectively.

At the time period t13, the first gate signal output module 11 outputs the gate driving signal to the gate line G5, and the first data signal output module 21 outputs the data signals to the fifth row of pixel units (the pixel unit P51, the pixel unit P52 and the pixel unit P53) through the data lines D11, D12 and D13 respectively.

At the time period t21, the second gate signal output module 12 outputs the gate driving signals to the gate line G2, and the second data signal output module 22 outputs the data signals to the second row of pixel units (the pixel unit P21, the pixel unit P22 and the pixel unit P23) through the data lines D21, D22 and D23 respectively.

At the time period t22, the second gate signal output module 12 outputs the gate driving signals to the gate line G2, and the second data signal output module 22 outputs the data signals to the fourth row of pixel units (the pixel unit P41, the pixel unit P42 and the pixel unit P43) through the data lines D21, D22 and D23 respectively.

The display apparatus in the present embodiment reduces the scanning time of each image frame, thereby improving the refresh rate of the display apparatus. It should be noted that the above embodiments are only some embodiments and the used technical principle of the present disclosure. Those skilled in the art shall understand that the present disclosure is not limited to the specific embodiments described herein, and can carry out various apparent changes, readjustments and substitutions without departing from a scope of the present disclosure. Therefore, although the present disclosure is described in detail through the above embodiments, the present disclosure is not only limited to the above embodiments, and can also include other more equivalent embodiments without departing from the conception of the present disclosure. The scope of the present disclosure is determined by the attached claims.

What is claimed is:

1. A driving circuit of a display apparatus, comprising:
a first gate signal output module, electrically connected to a first pixel unit group through a first group of gate lines;
a second gate signal output module, electrically connected to a second pixel unit group through a second group of gate lines;
a first data signal output module, electrically connected to the first pixel unit group through a first group of data lines and configured to output data signals to data lines in the first group of data lines; and
a second data signal output module, electrically connected to the second pixel unit group through a second group of data lines and configured to output data signals to data lines in the second group of data lines,
wherein when displaying an image frame, the first gate signal output module is configured to output a gate driving signal to gate lines in the first group of gate lines successively; and the second gate signal output module is configured to output the gate driving signal to gate lines in the second group of gate lines successively while the first gate signal output module is outputting the gate driving signal to the gate lines in the first group of gate lines successively.

2. The driving circuit according to claim 1, wherein the display apparatus comprises a plurality of gate lines, the first group of gate lines are odd-numbered gate lines of the plurality of gate lines, and the second group of gate lines are even-numbered gate lines of the plurality of gate lines, and
the first gate signal output module is configured to output the gate driving signal to the odd-numbered gate lines of the plurality of gate lines successively; and the second gate signal output module is configured to: output the gate driving signal to the even-numbered gate lines of the plurality of gate lines successively while the first gate signal output module is outputting the gate driving signal to the odd-numbered gate lines of the plurality of gate lines successively.

3. The driving circuit according to claim 1, wherein the display apparatus comprises a plurality of pixel units arranged in an array, the first pixel unit group includes the first N rows of pixel units of the plurality of pixel units, and the second pixel unit group includes the last M rows of pixel units of the plurality of pixel units, wherein M and N are positive integers greater than or equal to 1, and M+N is equal to total number of the rows of the plurality of pixel units.

4. The driving circuit according to claim 1, wherein the display apparatus comprises a plurality of pixel units arranged in an array, the first pixel unit group includes the first N columns of pixel units of the plurality of pixel units, and the second pixel unit group includes the last M columns of pixel units of the plurality of pixel units, wherein M and N are positive integers greater than or equal to 1, and M+N is equal to total number of the columns of the plurality of pixel units.

5. The driving circuit according to claim 1, wherein the gate lines in the first group of gate lines and the second group of gate lines extend in a first direction and are arranged in a second direction, and the data lines in the first group of data lines and the second group of data lines extend in the second direction and are arranged in the first direction; and
the first gate signal output module and the second gate signal output module are respectively arranged at two sides of the display apparatus in the first direction, and the first data signal output module and the second data signal output module are respectively arranged at two sides of the display apparatus in the second direction.

6. The driving circuit according to claim 1, wherein the first gate signal output module is arranged in a first gate Chip On Film (COF) region, and the second gate signal output module is arranged in a second gate Chip On Film (COF) region.

7. The driving circuit according to claim 1, wherein the first data signal output module is arranged in a first source Chip On Film (COF) region, and the second data signal output module is arranged in a second source Chip On Film (COF) region.

8. The driving circuit according to claim 7, wherein the first source COF region is electrically connected to a first flexible circuit board, and the second source COF region is electrically connected to a second flexible circuit board.

9. A display apparatus, comprising a display panel and a driving circuit, wherein
the display panel comprises:
a plurality of gate lines comprising a first group of gate lines and a second group of gate lines;
a plurality of data lines comprising a first group of data lines and a second group of data lines; and
a plurality of pixel units arranged in rows and columns and comprising a first pixel unit group and a second pixel unit group, and
the driving circuit comprises:
a first gate signal output module, electrically connected to the first pixel unit group through the first group of gate lines;
a second gate signal output module, electrically connected to the second pixel unit group through the second group of gate lines;
a first data signal output module, electrically connected to the first pixel unit group through the first group of data lines; and
a second data signal output module, electrically connected to the second pixel unit group through the second group of data lines;
wherein when displaying an image frame, the first gate signal output module is configured to output a gate driving signal to the first group of gate lines successively, and the first data signal output module outputs data signals to the first group of data lines successively; and
meanwhile, the second gate signal output module outputs the gate driving signal to the second group of gate lines successively, and the second data signal output module outputs data signals to the second group of data lines successively.

10. The display apparatus according to claim 9, wherein the first pixel unit group includes odd-numbered rows of the plurality of pixel units, and the second pixel unit group includes even-numbered rows of the plurality of pixel units.

11. The display apparatus according to claim 9, wherein the first pixel unit group includes the first N rows of the plurality of pixel units, and the second pixel unit group includes the last M lines of pixel units of the plurality of pixel units, wherein M and N are positive integers greater than or equal to 1, and M+N is equal to total number of the rows of the plurality of pixel units.

12. The display apparatus according to claim 9, wherein the first pixel unit group includes the first N columns of the plurality of pixel units, and the second pixel unit group includes the last M columns of the plurality of pixel units, wherein M and N are positive integers greater than or equal to 1, and M+N is equal to total number of the columns of the plurality of pixel units.

13. The display apparatus according to claim 9, wherein the plurality of gate lines extend in a first direction and are arranged in a second direction, and the plurality of data lines extend in the second direction and are arranged in the first direction; and
the first gate signal output module and the second gate signal output module are respectively arranged at two sides of the display apparatus in the first direction, and the first data signal output module and the second data signal output module are respectively arranged at another two sides of the display apparatus in the second direction.

14. The display apparatus according to claim 9, wherein the first gate signal output module is arranged in a first gate Chip On Film (COF) region, and the second gate signal output module is arranged in a second gate Chip On Film (COF) region.

15. The display apparatus according to claim 9, wherein the first data signal output module is arranged in a first source Chip On Film (COF) region, and the second data signal output module is arranged in a second source Chip On Film (COF) region.

16. The display apparatus according to claim 15, wherein the first source COF region is electrically connected to a first flexible circuit board, and the second source COF region is electrically connected to a second flexible circuit board.

17. A display apparatus, comprising a display panel and a driving circuit, wherein, the display panel comprises:
m gate lines comprising i first gate lines and j second gate lines;
2n data lines comprising n first data lines and n second data lines; and
a pixel unit array including pixel units arranged in m rows and n columns, and
the driving circuit comprises:
a first gate signal output module, electrically connected to the i first gate lines;
a second gate signal output module, electrically connected to the j first gate lines;
a first data signal output module, electrically connected to the n first data lines; and
a second data signal output module, electrically connected to the n second data lines,
wherein the pixel units comprises i first pixel unit groups and j second pixel unit groups;
each of the i first pixel unit groups is electrically connected to a respective one of the i first gate lines, and electrically connected to the n first data lines; and each of the j second pixel unit groups is electrically connected to a respective one of the j second gate lines, and electrically connected to the n second data lines, wherein i, j, m and n are positive integers greater than 1, and i+j=m.

18. The display apparatus according to claim 17, wherein i=j, the i first pixel unit groups are odd-numbered rows of the pixel unit array, and the j second pixel unit groups are even-numbered rows of the pixel unit array.

19. The display apparatus according to claim 17, wherein the i first pixel unit groups are i rows of the pixel unit array, and the j second pixel unit groups are other j rows of the pixel unit array.

20. The display apparatus according to claim 17, wherein the first gate signal output module is configured to output a gate driving signal to the i first gate lines successively; and the second gate signal output module is configured to: output the gate signal to the j second gate lines successively while the first gate signal output module is outputting the gate driving signal to the i first gate lines successively.
